(19) United States
(12) Patent Application Publication
(10) Pub. No.: US 2017/0088396 A1
(43) Pub. Date: Mar. 30, 2017

(54) ROBUST STARTUP METHOD FOR ROPELESS ELEVATOR

(71) Applicant: Otis Elevator Company, Farmington, CT (US)

(72) Inventor: Richard N. Fargo, Plainville, CT (US)

(21) Appl. No.: 15/125,379

(22) PCT Filed: Mar. 14, 2014
(86) PCT No.: PCT/US2014/027924

§ 371 Date: Sep. 12, 2016

(51) Int. Cl. B66B 1/32; B66B 5/00; B66B 1/30; B66B 9/00; B66B 11/04

(52) U.S. Cl. CPC B66B 1/32; B66B 9/003; B66B 11/0407; B66B 1/30; B66B 5/0018

(57) ABSTRACT

A method of startup from a resting state for a ropeless elevator system and a ropeless elevator system are disclosed. The ropeless elevator system may include a hoistway. The method for startup may include applying a thrust force on the brake, the thrust force generated by a propulsion system, detecting the thrust force on the brake, determining if the thrust force on the brake is greater than or equal to a requisite thrust force for startup, and disengaging the brake if the thrust force on the brake is greater than or equal to the requisite thrust force.

### TECHNICAL FIELD OF THE DISCLOSURE

The present disclosure relates generally to elevator systems and, more particularly, to self-propelled elevator systems.

### BACKGROUND OF THE DISCLOSURE

Self-propelled elevator systems, also referred to as ropeless elevator systems, are envisioned as useful in various applications, such as high rise buildings, where there is a desire for multiple elevator cars in a single hoistway portion of the elevator system. In high rise buildings, a conventional elevator may be prohibitive due to the mass of the ropes needed for function.

In ropeless elevator systems, a first hoistway may be designated for upward travel of the elevator cars while a second hoistway is designated for downward travel of the elevator cars. Further, transfer stations may be included to move the elevator cars horizontally between the first and second hoistways.

In a conventional elevator system, elevator cars may include braking systems to prevent downward acceleration prior to engaging a torque-driven drive. Such braking systems may have included systems for monitoring the torque applied to the elevator car prior to startup of elevator motion. An example system may sense a requisite level of torque applied to the brakes of the elevator and once a requisite torque is sensed, the break is released. Pre-torque verification methods are intended to prevent “rollback” of the elevator car, which is upward or downward movement of the car when the brake is lifted. Such systems and methods for monitoring a braking system for a conventional elevator may be further described in P.C.T. International Publication No. 2010/104502 (“Brake Torque Control”).

However, much of the rollback forces created by gravity in a conventional elevator system are counteracted by a counterweight. A ropeless elevator system does not have a counterweight to counteract gravitational forces which may cause rollback. While rollback in a conventional elevator system may be small due to the counterweight, rollback in a ropeless elevator may experience full gravitational acceleration (9.8 meters/second²) without a counterbalancing force from a counterweight. Further, existing pre-torque startup methods are not applicable to ropeless elevator systems because there is no rope-associated torque involved. Therefore, systems and methods for ensuring a safe startup with minimal rollback for a ropeless elevator system are needed.

### SUMMARY OF THE DISCLOSURE

In accordance with one aspect of the disclosure, a method for startup of an elevator car in a ropeless elevator system is disclosed. The ropeless elevator system may include a hoistway. The method may include applying a thrust force on the brake, the thrust force generated by a propulsion system, detecting the thrust force on the brake, determining if the thrust force on the brake is greater than or equal to a requisite thrust force for startup, and disengaging the brake if the thrust force on the brake is greater than or equal to the requisite thrust force.

In a refinement, the thrust force on the brake may be a force that causes a compression in a compliant brake mount associated with the brake.

In a further refinement, the thrust force on the brake is determined by measuring a level of strain on the compliant brake mount associated with the brake.

In a refinement, the elevator system may include a second brake associated with the elevator car.

In a further refinement, the method may further include applying a thrust force on the second brake using the propulsion system, determining a thrust force on the second brake, determining a total thrust, the total thrust being the sum of the thrust force at the first brake and the thrust force at the second brake, determining if the total thrust is greater than or equal to the requisite thrust force for startup, and disengaging the brake and the second brake if the thrust force is greater than or equal to the requisite thrust force.

In a further refinement, the method may further include determining the difference between the thrust force on the first brake and the thrust force on the second brake and if the difference between the thrust force on the first brake and the thrust force on the second brake exceeds a specified limit, aborting startup of the elevator car.

In a refinement, the requisite thrust force for startup may be a thrust force greater than or equal to a combined weight of the elevator car and a passenger load associated with the elevator car.

In a refinement, the method may further include, if the thrust force on the brake is less than the requisite thrust force for startup, adjusting the thrust force on the brake using the propulsion system to make the thrust force on the brake greater than or equal to the requisite thrust force for startup.

In a refinement, the method may further include monitoring the brakes for brake dragging using determined thrust force values.

In a refinement, the propulsion system may include a magnet associated with the elevator car and windings associated with the hoistway and an interaction between the magnet and the windings generates the thrust force.

In a further refinement, the method may further include detecting a location of the elevator car in the hoistway using a hall effect sensor, wherein the hall effect sensor senses a magnetic field associated with the propulsion system to detect the location of the elevator car.

In a further refinement, the method may further include determining if the magnet is properly aligned with the windings using the detected location of the elevator car in the hoistway.

In accordance with another aspect of the disclosure, a ropeless elevator system is disclosed. The ropeless elevator system may include an elevator car, a hoistway in which the elevator car travels, a brake associated with the elevator car, and a propulsion system for moving the elevator car about the hoistway, the propulsion system applying a thrust force on the brake. The ropeless elevator system may further include a thrust sensor that detects the thrust force on the brake and determines if the thrust force on the brake is greater than or equal to a requisite thrust force for startup, the brake disengaging if the thrust sensor determines that the thrust force on the brake is greater than or equal to the requisite thrust force.

In a refinement, the thrust sensor may include a compliant brake mount associated with the brake, the compliant brake mount detecting a strain caused by the thrust force on the brake.

In a refinement, the ropeless elevator system may further include a second brake associated with the elevator car and a second brake sensor, the second brake sensor determining a thrust force applied to the second brake.

In a further refinement, the brake and the second brake may be disengaged if a total thrust applied is greater than or equal to the requisite thrust force for startup, the total thrust being the sum of the thrust force at the first brake and the thrust force at the second brake.

In a refinement, the propulsion system may include a magnet associated with the elevator car and windings associated with the hoistway and an interaction between the magnet and the windings generates the thrust force.

In a further refinement, the ropeless elevator system may further include a hall effect sensor disposed in the hoistway, the hall effect sensor detecting a location of the elevator car in the hoistway by sensing a magnetic field associated with the propulsion system.

In a further refinement, the hall effect sensor determines if the magnet is properly aligned with the windings using the detected location of the elevator car in the hoistway.

In accordance with another aspect of the disclosure, a ropeless elevator system is disclosed. The ropeless elevator system may include an elevator car, a first hoistway in which the elevator car travels upward, a second hoistway in which the elevator car travels downward, an upper transfer station positioned above the first hoistway and the second hoistway, a lower transfer station positioned below the first hoistway and the second hoistway, the elevator car moveable from the first hoistway to the second hoistway when disposed in the upper transfer station or the lower transfer station, a brake associated with the elevator car, and a propulsion system for moving the elevator car about the hoistway, the propulsion system applying a thrust force on the brake. The ropeless elevator system may further include a thrust sensor that detects the thrust force on the brake and determines if the thrust force on the brake is greater than or equal to a requisite thrust force for startup, the brake disengaging if the thrust sensor determines that the thrust force on the brake is greater than or equal to the requisite thrust force.

### BRIEF DESCRIPTION OF THE DRAWINGS

FIG. 1 is a ropeless elevator system according to an exemplary embodiment.

FIG. 2 is a top down view of an elevator car in a hoistway in an exemplary embodiment.

FIG. 3 is a top down view of a moving portion of a propulsion system in an exemplary embodiment.

FIG. 4 is a top down view of a stationary portion and a moving portion of a propulsion system in an exemplary embodiment.

FIG. 5 is a perspective view of an elevator car and a propulsion system in an exemplary embodiment.

FIG. 6 is a schematic drawing of a propulsion system in an exemplary embodiment.

FIG. 7 is a side view of an exemplary elevator car in a hoistway and an example braking system associated with the elevator car.

FIG. 8 is a side view of an exemplary elevator car in a hoistway.

FIG. 9 is an example flow chart illustrating an embodiment of a startup method for a ropeless elevator system.

FIG. 10 is a continuation of the example flow chart of FIG. 9.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

Furthermore, while the present disclosure is susceptible to various modifications and alternative constructions, certain illustrative embodiments thereof will be shown and described below in detail. The invention is not limited to the specific embodiments disclosed, but instead includes all modifications, alternative constructions, and equivalents thereof.

### DETAILED DESCRIPTION OF THE DRAWINGS

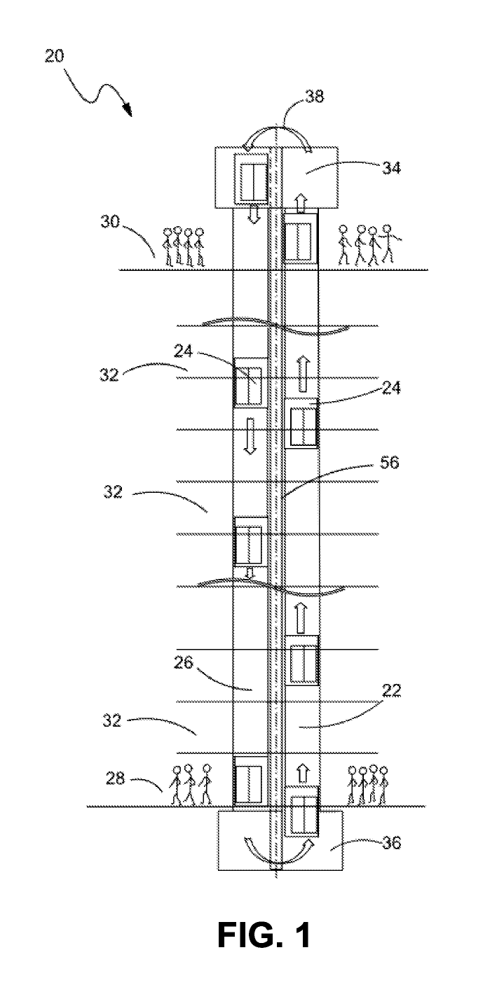

Referring now to FIG. 1, an exemplary embodiment of a ropeless elevator system 20 is shown. The elevator system 20 is shown for illustrative purposes to assist in disclosing various embodiments of the invention. As is understood by a person skilled in the art, FIG. 1 does not depict all of the components of an exemplary ropeless elevator system, nor are the depicted features necessarily included in all ropeless elevator systems.

The ropeless elevator system 20 may include a first hoistway 22 in which one or more elevator cars 24 travel upward and a second hoistway 26 in which the elevator cars 24 travel downward. The ropeless elevator system 20 may transport elevator cars 24 from a first floor 28 to a top floor 30 in the first hoistway 22. Conversely, the ropeless elevator system 20 may transport elevator cars 24 from the top floor 30 to the first floor 28 in the second hoistway 26. Further, the elevator cars 24 may also stop at intermediate floors 32 to allow ingress to and egress from an elevator car 24. The intermediate floors 32 may include any floors associated with the first hoistway 22 and/or the second hoistway 26 in between the top floor 30 and the first floor 28.

Above the top floor 30, an upper transfer station 34 may be positioned across the first and second hoistways 22, 26. The upper transfer station 34 may impart horizontal motion to elevator cars 24 to move the elevator cars 24 from the first hoistway 22 to the second hoistway 26. It is understood that upper transfer station 34 may be located at the top floor 30, rather than above the top floor 30. Additionally, a lower transfer station may be positioned across the first and second hoistways 22, 26 below the first floor 28. The lower transfer station 36 may impart horizontal motion to the elevator cars 24 to move the elevator cars 24 from the second hoistway 26 to the first hoistway 22. It is to be understood that lower transfer station 36 may be located at the first floor 28, rather than below the first floor.

The first hoistway 22, the upper transfer station 34, the second hoistway 26, and the lower transfer station 26 may comprise a loop 38 in which the cars 24 circulate to the plurality of floors 28, 30, 32 and stop to allow the ingress and egress of passengers to the floors 28, 30, 32.

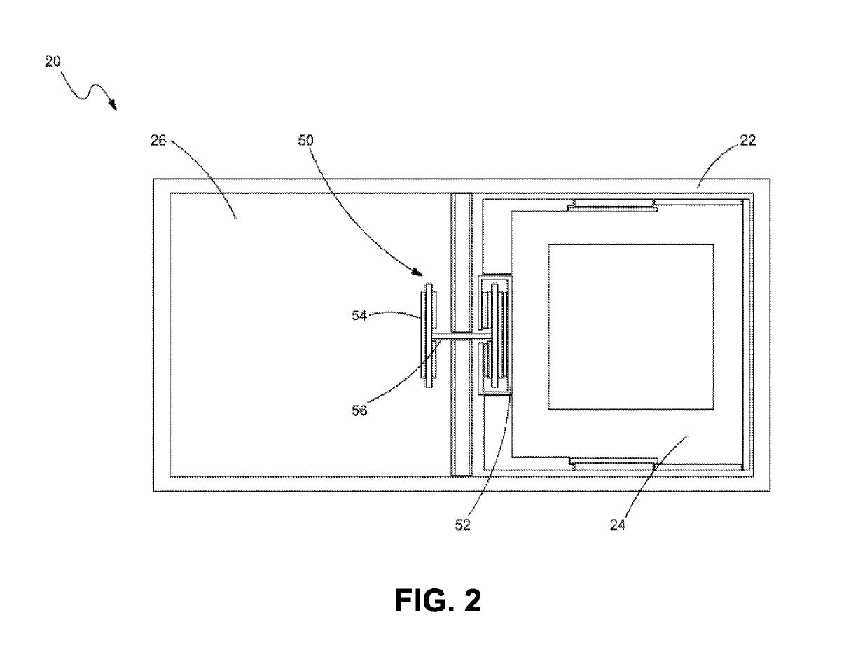

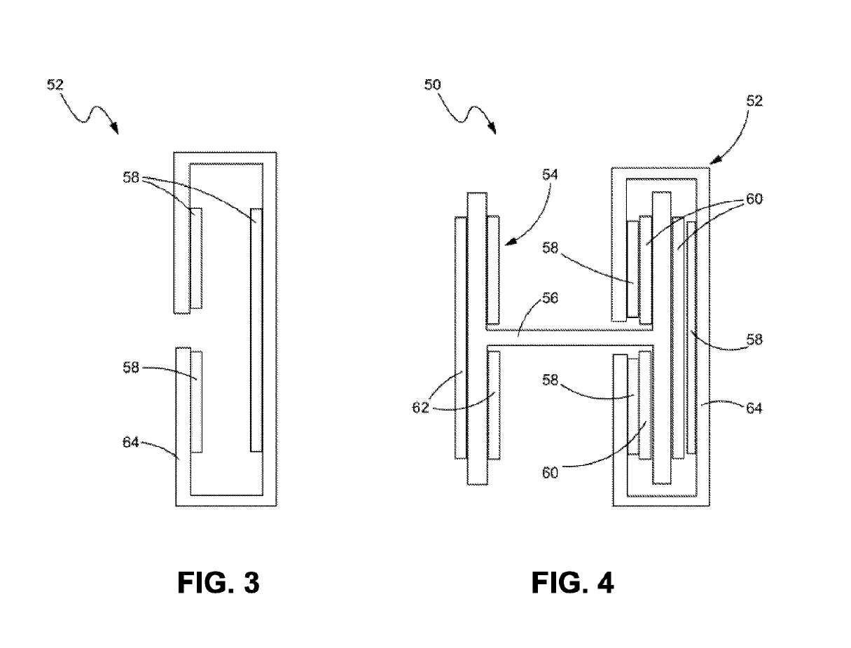

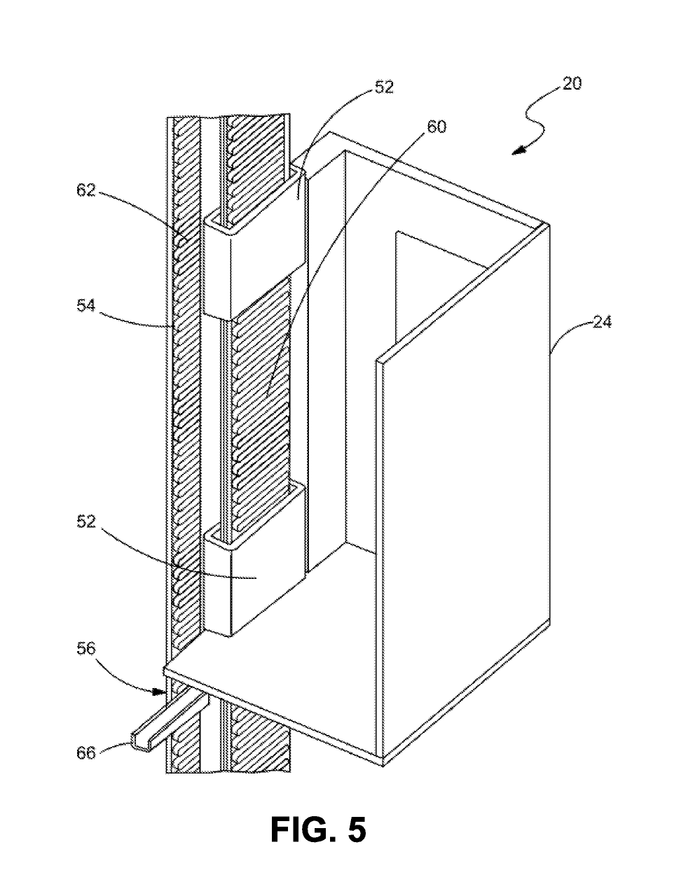

With reference to FIGS. 2-6, a propulsion system 50, which may be included in the elevator system 20, is shown. The propulsion system 50 may be disposed on the elevator cars 24 in the hoistways 22, 26 and in the transfer stations 34, 36. The propulsion system 50 may generate thrust to impart vertical motion to elevator cars 24 to propel the elevator cars 24 from one level to the next within the hoistways 22, 26 and into and out of the transfer stations 34, 36. In turn, the thrust force on an elevator car 24 may transfer to elements associated with the car 24, such as one or more brakes. The propulsion system 50 may comprise a moving part 52 mounted on each elevator car 24 and a stationary part 54 mounted to a structural member 56 positioned within the hoistways 22, 26 and/or transfer stations 34, 36. The interaction of the moving part 52 and the stationary part 54 generates a thrust force to move the elevator cars 24 in a vertical direction within the hoistways 22, 26 and transfer stations 34, 36.

In an example, the moving part 52 includes permanent magnets 58, while the stationary part 54 includes windings 60, 62 mounted on the structural member 56. Permanent magnets 58 may be attached to a support element 64 of the moving part 52, with the support element 64 coupled to the elevator car 24. Structural member 56 may be made of a ferromagnetic material and coupled to a wall of the first and/or second hoistways 22, 26 by support brackets 66. Windings 60, 62 may be formed about structural member 56. Windings 60 may comprise the stationary part of the propulsion system within the first hoistway 22 and windings 62 may comprise the stationary part of the propulsion system within the second hoistway 26. A support element 64 of the moving part 52 may be positioned about windings 60, 62 such that the windings 60, 62 and permanent magnets 58 are adjacent.

Windings 60 in the first hoistway 22 may be energized by a power source 68 to propel one or more elevator cars 24 upward in the first hoistway 22 and transfer stations 34, 36. When a voltage is applied to windings 60, the interaction between windings 60 and permanent magnets 58 impart motion to the elevator car 24. Windings 62 in the second hoistway 26 operate as a regenerative brake to control descent of the elevator car 24 in the second hoistway 26 and transfer stations 34, 36. Windings 62 may also provide a current back to the drive unit, for example, to recharge an electrical system.

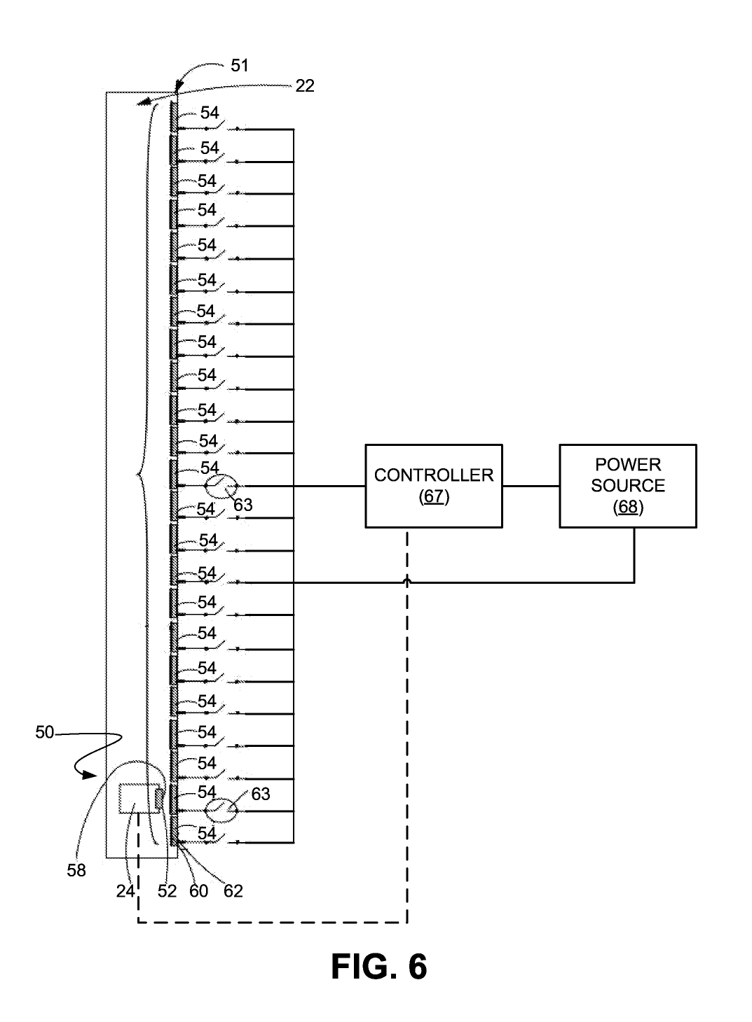

FIG. 6 further illustrates an example propulsion system 50 having a track 51 disposed in the hoistway 22. The track 51 may comprise a plurality of stationary parts 54. Similar to FIGS. 2-5, each stationary part 54 includes a plurality of windings 60 mounted thereto. Each stationary part 54 may be individually energized by the power supply 68, wherein the power from the power supply 68 may be activated/deactivated using a respective member of the plurality of switches 63 associated with the plurality of stationary parts 54.

The elevator car 24, including the moving part 52, may be disposed along the track 51. The moving part 52, including the permanent magnet 58, may interact with the plurality of stationary parts 54. The windings 60 of a stationary part 54 may receive power from the power supply 68 when the moving part 52 of the elevator car 24 is aligned with the stationary part 56 on the track 51. The controller 57 may send/receive signals to/from the stationary parts 56 to activate members of the plurality of stationary parts 56 where the elevator car 24 is located to propel the elevator car 24.

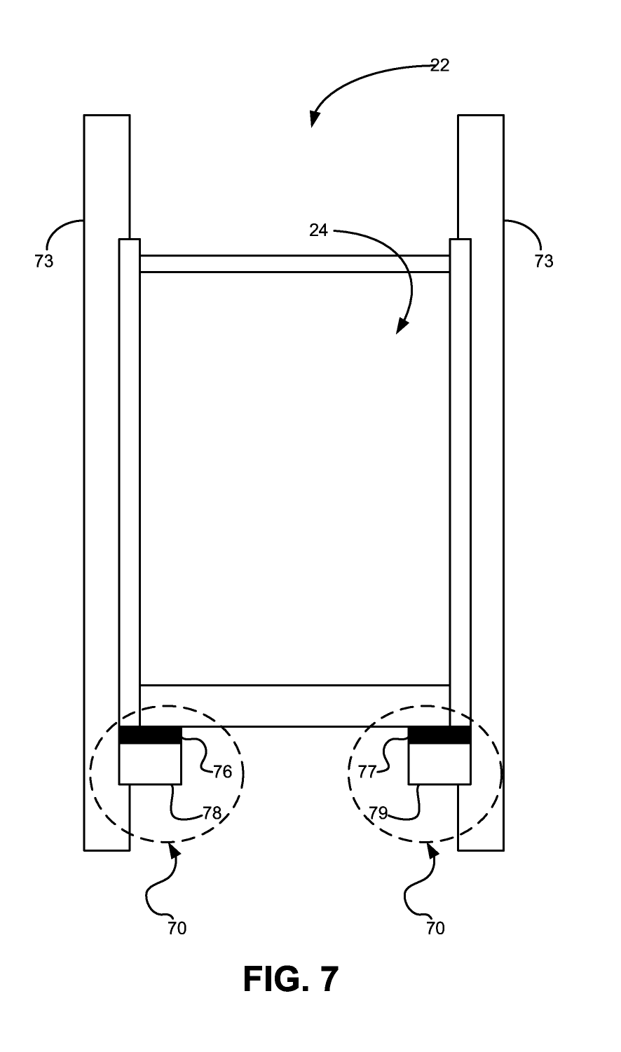

Turning now to FIG. 7, a braking system 70 associated with the elevator car 24 is shown. The elevator car 24 may be operatively associated with guide rails 73, the guide rails 73 associated with either the first hoistway 22 or the second hoistway 26. In the present example, the elevator car 24 travels vertically along the guide rails 73. However, in some embodiments, the elevator car 24 may travel horizontally along horizontally situated guide rails. For example, when the elevator car is moving between first and second hoistways 22, 26 at a transfer station, the elevator car 24 may travel along horizontally situated guard rails.

The braking system 70 included may use one or more brakes 76, 77 configured to apply a braking force to resist movement of the elevator car 24 within the first and/or second hoistways 22, 26. Additionally, the braking system 70 may include a thrust sensor 78 that detects a thrust force on the brake 76 and may determine if the thrust force on the brake 76 is within a range of thrust values corresponding to a requisite thrust force for startup. The thrust force on the brake 76 may be a thrust force applied to the elevator car 24 which, in turn, is transferred to the brake 76. For example, the thrust sensor 78 may be configured to only release the brake when the thrust produced by the propulsion system 50, as applied to the brake, is greater than the weight elevator car 24 and its associated passenger load (e.g., passengers, freight, etc.). In such examples, if M_{EC} is the mass of the elevator car 24, M_{PL} is the mass of the passenger load, g is the acceleration of gravity, T_{P} is the propulsion system thrust, and T_{req} is the requisite amount of thrust on the brake 76 required for startup, then:

T_{req}=[(M_{EC}+M_{PL})*g]−T_{P}
The requisite thrust value for lifting the brake should be 0, or, when the combined weight of the elevator car and its load is equal to the thrust of the propulsion system. Upon sensing the requisite thrust force for startup, the thrust sensor may indicate that the brake 76 is able to be released if the detected force is greater than or equal to the requisite thrust force for startup.

The thrust sensor 78 may include a compliant brake mount configured to mount the brake to the elevator car. The compliant brake mount may be a sensing apparatus which detects strain in reaction to a detected force. For example, the compliant brake mount may detect strain in the form of compression of the compliant brake mount, tension affecting the compliant brake mount, shear forces affecting the compliant brake mount, bending of the compliant brake mount, and the like. In such examples, the thrust sensor 78 may be configured to detect thrust and/or determine the level of thrust by monitoring levels of compression of the compliant brake mount. Additionally or alternatively, the thrust sensor 78 may include one or more microswitches and/or one or more proximity sensors to determine thrust applied to the brake 76.

Further, the thrust sensor 78 may be used to determine if the elevator car 24 has been overloaded. In some operational scenarios, the passenger load may be too heavy for the elevator system 20 to operate properly. Thus, the braking system 70 may determine that the weight of the passenger load in addition to the weight of the elevator car is above a safety threshold for which the elevator system 20 may operate properly. When the combined weight of the passenger load and elevator car 24 exceeds the safety threshold, an overload message may be sent to the controller 57. Additionally, when the safety threshold is exceeded, the elevator system 20 may delay startup of the elevator system 20 until the overload situation is corrected.

In some examples, the braking system 70 may include a second brake 77 configured to apply a braking force to resist movement of the elevator car 24. The second brake 77 may be operatively associated with a second thrust sensor 79 which may detect thrust forces on the second brake 77 and determine if the thrust force on the second brake 77 is within a range corresponding to an acceptable amount of thrust on the second brake 77. The braking system 70 may use detected thrust levels from the thrust sensor 78 and the second thrust sensor 79 to verify that the detected force at the first thrust sensor 78 and the detected force at the second thrust sensor 79 are substantially similar. In so doing, the braking system 70 may verify that the load of the elevator car 24 and its contents are equally shared by the first and second brakes 76, 77. Said detected thrust values may also be used by the braking system 70 to determine the operability and/or failure of the first and/or second brakes 76, 77. While the braking system 70 of the present example shown in FIG. 6 includes two brakes and their respective thrust sensors, the braking system 70 is not limited to including only two brakes having respective thrust sensors and any acceptable number of brakes and/or associated sensors may be used.

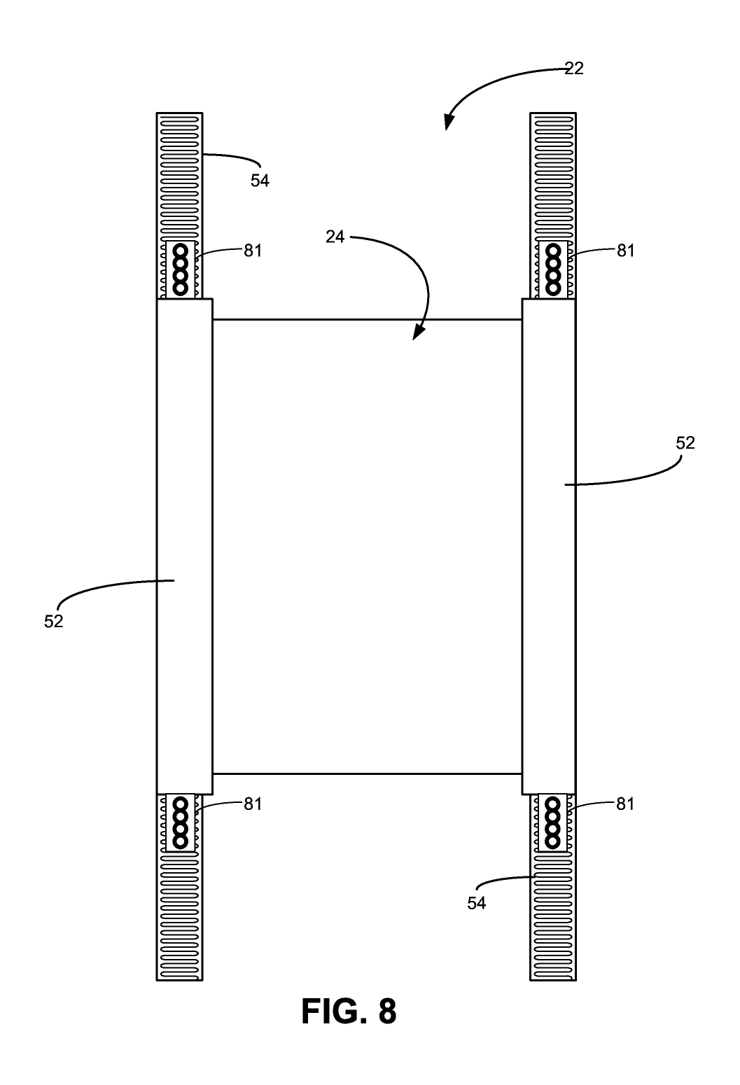

Turning now to FIG. 8, the elevator car 24 is shown in the hoistway 22, wherein an array of Hall effect sensors 81 are disposed on the elevator car 24 in close proximity to the stationary parts 54. A Hall effect sensor 81 is a transducer that produces an output voltage signal in response to magnetic fields and/or variances in magnetic fields. When the magnetic field of an object is known, its distance from a Hall effect sensor 81 can be determined. In the present example, the magnetic field produced by the windings 60 of a member of a plurality of stationary parts 54 may be known. Thus, the array of Hall effect sensors 81 can determine a relative position of the elevator car 24 when the magnetic field produced by the windings 60 is known. The array of Hall effect sensors 81 may determine if the permanent magnet 58 of the elevator car 24 is properly aligned with the windings 60, 62 which are to be energized to start up the elevator car 24.

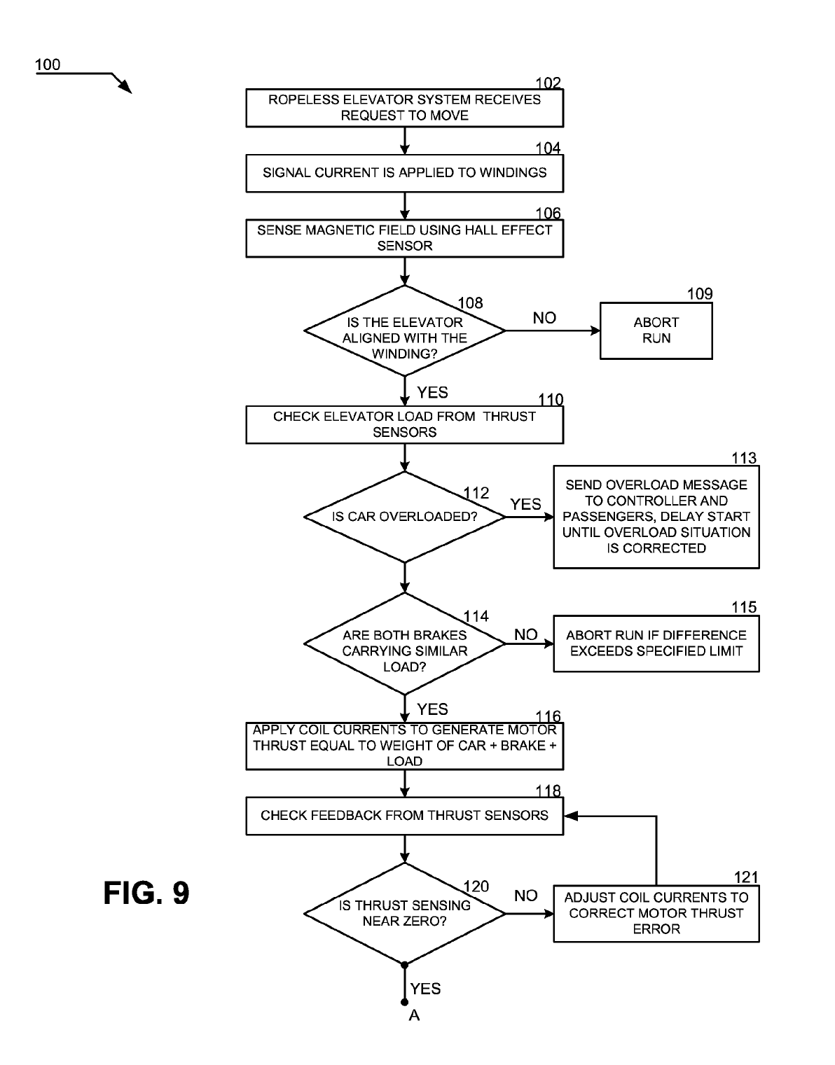

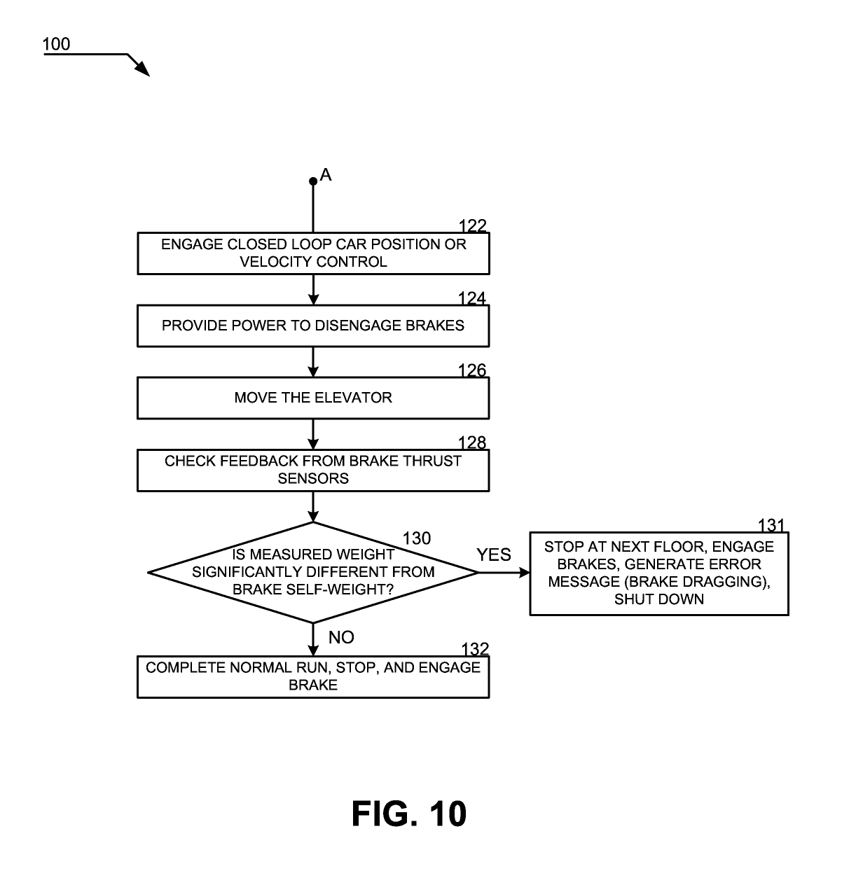

FIGS. 9 and 10 illustrate a flowchart 100 detailing a method for startup of an elevator car 24 within the ropeless elevator system 20. At block 102, the ropeless elevator system 20 receives a request to move. The request to move may come from the controller 57 and/or any other signals which the elevator system 20 recognizes as a valid request to move. If a valid request to move is received, a signal current will be applied to the windings 60, 62 (block 104). In some examples, one or more Hall effect sensors 81 associated with the elevator system 20 may be used to sense a magnetic field (block 106). If the Hall effect sensor(s) 81 determine that the elevator is aligned with the windings 60, 62 (decision 108), then the startup method continues; otherwise, the elevator run is aborted (block 109).

Weight of the elevator car and its contents is determined by the thrust sensor(s) 78, 79 (block 110). At decision 112, the method may use the weight feedback from the thrust sensor(s) 78, 79 to determine if the car is overloaded. If the car is overloaded, then an overload message may be sent to the controller 57 and/or to the passengers of the elevator car 24 and the startup method may be delayed until the overload situation is corrected (block 113).

At decision 114, the method may determine if two brakes 76, 77 are carrying a similar load. If the difference in load at the two brakes exceeds a specified limit, then the startup method may be aborted (block 115).

To start motion of the elevator car 24 within the hoistway 22, a current may be applied to generate a thrust greater than or equal to the weight of the car in addition to the weight of the passenger load (block 116). Once said generated thrust is applied, feedback from the braking sensor(s) 78, 79 is checked (118). If the brake sensing value is at or above requisite thrust value (decision 120), then the elevator system 20 may engage in closed loop car position or velocity control, provide power to disengage the brakes 76, 77, and/or move the elevator (blocks 122, 124, 126). If the brake sensing value is below the requisite thrust value, then the coil currents may be adjusted to correct the a motor thrust error (block 121).

In some example methods, the thrust sensors 78, 79 may monitor feedback while the elevator car 24 is moving about the hoistway 22 (block 128). In such examples, if the measured weight is significantly different from the weight of the brake itself (decision 130), then the elevator car 24 may stop at the next floor on the hoistway 22 and engage the brake(s) 76, 77 (block 131). When the measured weight is significantly different from the weight of the brake itself, it may be due to a dragging brake and an error message may be generated to alert operators of the dragging brake. If there is no brake dragging, the elevator system 20 may continue normal operation (block 132).

### INDUSTRIAL APPLICABILITY

From the foregoing, it can be seen that the technology disclosed herein has industrial applicability in a variety of settings such as, but not limited to, systems and methods for providing a startup method for ropeless elevator systems. Using the teachings of the present disclosure, ropeless elevator systems may be provided with proper systems and methods for safely monitoring braking activity. Such systems and methods may prevent or eliminate rollback of elevator cars within an elevator system. Further, said methods for startup and the systems herein may prevent brake lifting under faulty conditions and can detect a failing and/or dragging brake. The systems and methods herein may also provide for verification means with respect to the health of apparatus and individual apparatus functions associated with the elevator car.

While the present disclosure has been in reference to startup methods and braking systems for ropeless elevator systems, one skilled in the art will understand that the teachings herein can be used in other applications as well. It is therefore intended that the scope of the invention not be limited by the embodiments presented herein as the best mode for carrying out the invention, but that the invention will include all equivalents falling within the spirit and scope of the claims as well.

What is claimed is:

1. A method for startup of an elevator car (24) in a ropeless elevator system (20), the ropeless elevator system (20) including a hoistway (22), the method comprising:
applying a thrust force on the brake (76), the thrust force generated by a propulsion system (50);
detecting the thrust force on the brake (76);
determining if the thrust force on the brake (76) is greater than or equal to a requisite thrust force for startup;
disengaging the brake (76) if the thrust force on the brake (76) is greater than or equal to the requisite thrust force.

2. The method of claim 1, wherein the thrust force on the brake (76) is a force that causes a strain on a compliant brake mount associated with the brake.

3. The method of claim 2, wherein the thrust force on the brake (76) is determined by measuring a level of the compression in the compliant brake mount associated with the brake (76).

4. The method of claim 1, wherein the elevator system includes a second brake (77) associated with the elevator car (24).

5. The method of claim 4, further comprising:
applying a thrust force on the second brake (77) using the propulsion system (50);
determining a thrust force on the second brake (77);
determining a total thrust, the total thrust being the sum of the thrust force at the first brake (76) and the thrust force at the second brake (77);
determining if the total thrust is greater than or equal to the requisite thrust force for startup; and
disengaging the brake (76) and the second brake (77) if the thrust force is greater than or equal to the requisite thrust force.

6. The method of claim 5, further comprising:
determining the difference between the thrust force on the first brake (76) and the thrust force on the second brake (77); and
if the difference between the thrust force on the first brake (76) and the thrust force on the second brake (77) exceeds a specified limit, aborting startup of the elevator car (24).

7. The method of claim 1, wherein the requisite thrust force for startup is a thrust force greater than or equal to a combined weight of the elevator car (24) and a passenger load associated with the elevator car (24).

8. The method of claim 1, further comprising, if the thrust force on the brake is (76) less than the requisite thrust force for startup, adjusting the thrust force on the brake (76) using the propulsion system (50) to make the thrust force on the brake (76) greater than or equal to the requisite thrust force for startup.

9. The method of claim 1, further comprising monitoring the brakes for brake dragging using determined thrust force values.

10. The method of claim 1, wherein the propulsion system (50) includes a magnet (58) associated with the elevator car (24) and windings (60, 62) associated with the hoistway (22) and an interaction between the magnet (58) and the windings (60, 62) generates the thrust force.

11. The method of claim 10, further comprising detecting a location of the elevator car (24) in the hoistway (22) using a hall effect sensor (81), wherein the hall effect sensor (81) senses a magnetic field associated with the propulsion system (50) to detect the location of the elevator car (24).

12. The method of claim 11, further comprising determining if the magnet (58) is properly aligned with the windings (60, 62) using the detected location of the elevator car (24) in the hoistway (22).

13. A ropeless elevator system (20), comprising:
an elevator car (24);
a hoistway (22) in which the elevator car travels;
a brake (76) associated with the elevator car (24);
a propulsion system (50) for moving the elevator car (24) about the hoistway (22), the propulsion system (50) applying a thrust force on the brake (76);
a thrust sensor (78) that detects the thrust force on the brake (76) and determines if the thrust force on the brake (76) is greater than or equal to a requisite thrust force for startup, the brake (76) disengaging if the thrust sensor (78) determines that the thrust force on the brake (76) is greater than or equal to the requisite thrust force.

14. The ropeless elevator system (20) of claim 13, wherein the thrust sensor 78 includes a compliant brake mount associated with the brake (76), the compliant brake mount detecting a strain caused by the thrust force on the brake (76).

15. The ropeless elevator system (20) of claim 13, further comprising:
a second brake (77) associated with the elevator car (24); and
a second brake sensor (79), the second brake sensor determining a thrust force applied to the second brake (77).

16. The ropeless elevator system (20) of claim 15, wherein the brake (76) and the second brake (77) are disengaged if a total thrust applied is greater than or equal to the requisite thrust force for startup, the total thrust being the sum of the thrust force at the first brake (76) and the thrust force at the second brake (77).

17. The ropeless elevator system (20) of claim 13, wherein the propulsion system (50) includes a magnet (58) associated with the elevator car (24) and windings (60, 62) associated with the hoistway (22) and an interaction between the magnet (58) and the windings (60, 62) generates the thrust force.

18. The ropeless elevator system (20) of claim 17, further comprising a hall effect sensor (81) disposed in the hoistway (22), the hall effect sensor (81) detecting a location of the elevator car (24) in the hoistway (22) by sensing a magnetic field associated with the propulsion system (50).

19. The ropeless elevator system (20) of claim 18, wherein the hall effect sensor (81) determines if the magnet (58) is properly aligned with the windings (60, 62) using the detected location of the elevator car (24) in the hoistway (22).

20. A ropeless elevator system (20), comprising:
an elevator car (24);
a first hoistway (22) in which the elevator car (24) travels upward;
a second hoistway (26) in which the elevator car (24) travels downward;
an upper transfer station (34) positioned above the first hoistway (22) and the second hoistway (26);
a lower transfer station (36) positioned below the first hoistway (22) and the second hoistway (26), the elevator car (24) moveable from the first hoistway (22) to the second hoistway (26) when disposed in the upper transfer station (34) or the lower transfer station (36);
a brake (76) associated with the elevator car (24);
a propulsion system (50) for moving the elevator car (24) about the hoistway (22), the propulsion system (50) applying a thrust force on the brake (76);
a thrust sensor (78) that detects the thrust force on the brake (76) and determines if the thrust force on the brake (76) is greater than or equal to a requisite thrust force for startup, the brake (76) disengaging if the thrust sensor (78) determines that the thrust force on the brake (76) is greater than or equal to the requisite thrust force.
